(19) United States
(12) Patent Application Publication
(10) Pub. No.: US 2002/0073689 A1
(43) Pub. Date: Jun. 20, 2002

(54) Ion engine

(76) Inventor: Chao-Yuan Liang, Taipei (TW)

Correspondence Address: Chao-Yuan LIANG, P.O. Box No.6-57, Chung-Ho, Taipei, 235, TW

(21) Appl. No.: 09/988,093

(22) Filed: Nov. 19, 2001

(30) Foreign Application Priority Data
Nov. 22, 2000 (TW) 89116441

(51) Int. Cl. F03H 1/00

(52) U.S. Cl. 60/202

(57) ABSTRACT

The present invention provides an ion engine, more particularly an ion engine using the inconsumable specialty of a super conductor to make the electromagnetic impulse generated thereby produce continuous and ceaseless energy; mainly, two gassed sides of a dynamo are disposed with super conductors; since the said super conductors have inconsumable specialty, the released high voltage therefrom influences the gas inside the dynamo to ionize and further generate continuous and endless electric current.

### BACKGROUND OF THE INVENTION

1) Field of the Invention

The present invention provides an ion engine, more particularly an ion engine using the inconsumable specialty of a super conductor to make the electromagnetic impulse generated thereby produce continuous and ceaseless energy.

2) Description of the Prior Art

Accordingly, the indispensable dynamic force of energy source in the nowadays life generates energy through heat, nuclear power, hydraulic, and wind driven dynamos. The said heat dynamo not only might damage the atmospheric ecology and cause environmental pollution, but also enhance the greenhouse effect, damage the ozone sphere, or even cause air and water pollution; furthermore, since the nuclear power dynamo generates nuclear waste and the potential crisis of environmental pollution caused by nuclear leakage; the hydraulic dynamo is usually influenced by the topography and the water flow; the wind driven dynamo is limited somehow by the influence of the weather and the wind direction.

No matter which kind of method is used to generate electric energy, the electromagnetic impulse generated thereby will consume to waste the energy; therefore, while endeavoring in energy development, how to protect the purity of the environmental ecology to enable the ecology of the Mother Nature everlasting is a very important issue.

In view of the mentioned reasons, the inventor of the present invention addressed the shortcomings easily derived from the energy generation through heat, nuclear power, hydraulic, and wind driven dynamos, based on the rich experience in studying the energy for many years, researched and invented with tremendous committed ideas and efforts, after a long period of research and experiment, finally developed the present invention of an ion engine to eliminate the damage and harm easily caused by the said methods of energy generation.

### SUMMARY OF THE INVENTION

Specifically, the present invention of an ion engine mainly has a super conductor disposed on two gassed sides of a dynamo; since the said super conductors have inconsumable specialty, the released high voltage therefrom influences the gas inside the dynamo to ionize and further generate continuous and endless electric current (electromagnetic impulse).

The primary objective of the present invention is to generate continuous and endless electric current by using the said super conductors to ionize the gas inside the dynamo so as to provide continuous and endless energy to various electric products.

Another objective of the present invention is to use the continuous and endless energy generated by the said dynamo to eliminate the crises of ecological damage, environmental pollution, enhancement of greenhouse effect, damage of ozone sphere, air and water pollution derived from energy development.

To enable a further understanding of the structural features and the technical contents, the brief description of the drawings below is followed by the detailed description of the preferred embodiment.

### BRIEF DESCRIPTION OF THE DRAWINGS

FIG. 1 is a schematic drawing of the super conductor of the present invention.

FIG. 2 is a drawing of an exemplary embodiment of the present invention.

FIG. 3 is a drawing of the electromagnetic impulse of the present invention.

FIG. 4 is a schematic drawing of the application of the present invention.

### DETAILED DESCRIPTION OF THE PREFERRED EMBODIMENTS

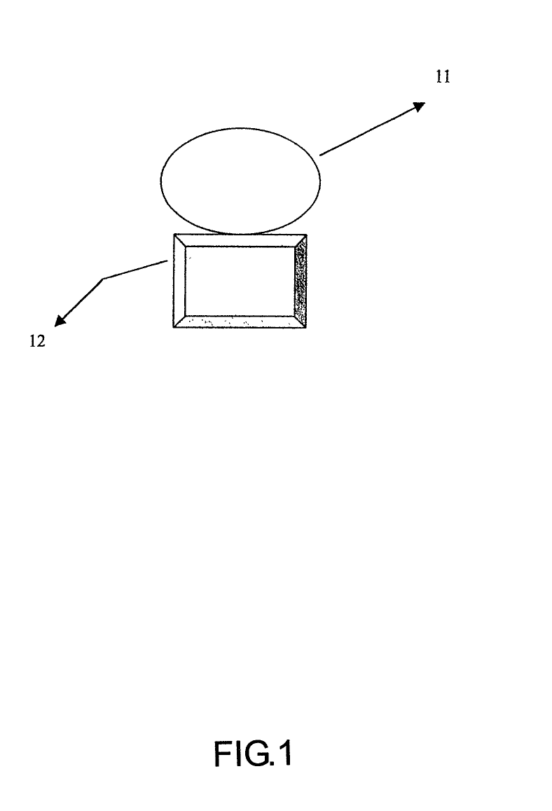

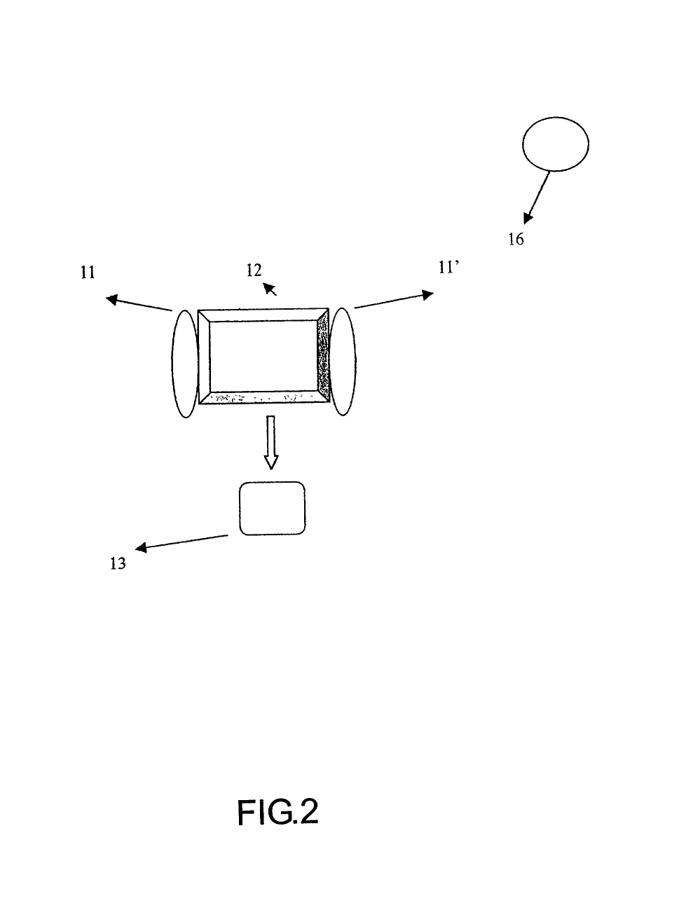

Referring to FIGS. 1 and 2, the present invention of an ion engine mainly comprises a dynamo (12) and super conductors (11, 11′), wherein the inside of the dynamo (12) has gas (such as hydrogen) while the super conductors (11, 11′) are disposed on two sides of the dynamo (12) and possess the inconsumable specialty.

When super conductors (11, 11′) operate and release high voltage, the gas inside the dynamo (12) influenced by the high voltage produces ionizing phenomenon; the said ionizing phenomenon thereby generates continuous and endless electromagnetic impulse (14) so as to connect the said electromagnetic impulse to the electric products (13) for providing continuous and endless energy.

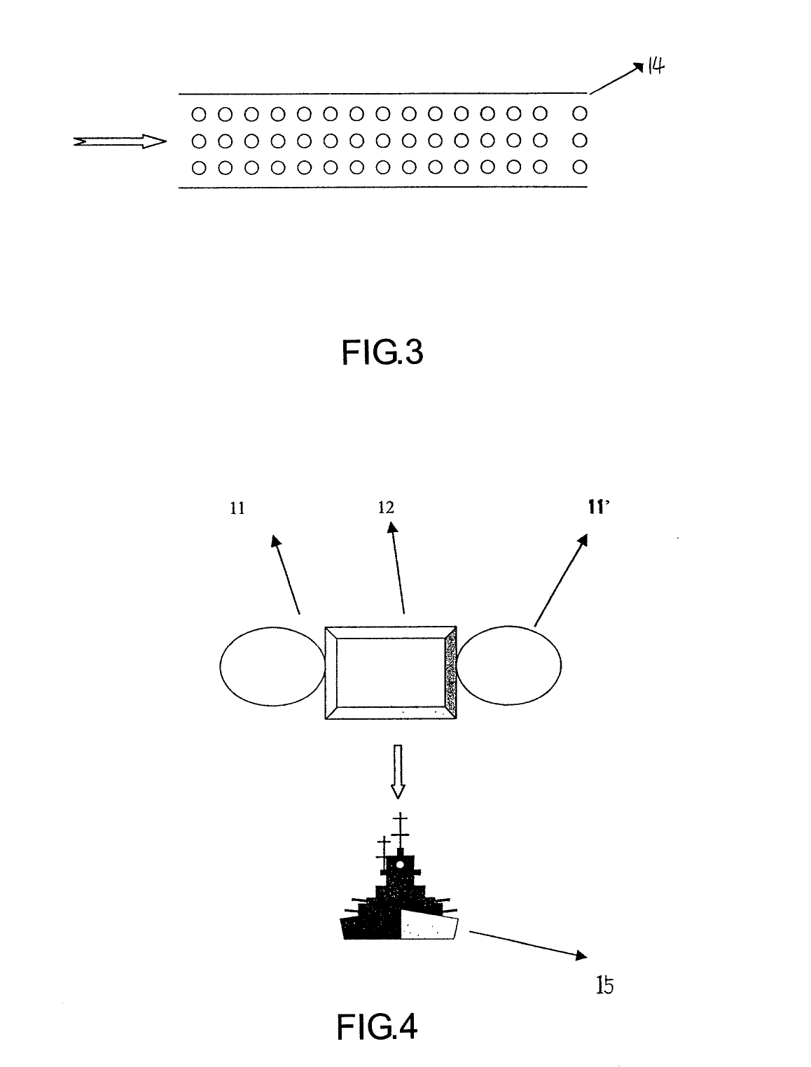

Referring to FIGS. 1 to 4, when the energy source (16) generates electromagnetic impulse (14) through super conducts (11, 11′), it does not influence the output of electromagnetic impulse at all, thereby, the objective of completely applying the energy and energy source can be achieved.

Furthermore, since the continuous and endless energy generated by the present invention utilizes the inconsumable specialty of super conductors (11, 11′) on two sides of the dynamo (12), the electromagnetic impulse (14) generated thereby can be connected outwardly to the electric product (13) or even applied to the energy supply of the ship (15), or to an automobile, a motorcycle, a magnetic levitated architecture, a submarine, a missile, a flight device, a space shuttle, a mobile phone, a computer, laser, the life medicine and all of the electric products using electricity as the energy source.

Since the inconsumable specialty of super conductor (11, 11′) can generate ceaseless electromagnetic impulse (14), it is not necessary to use the electric generating methods that might consume energy, waste energy source and pollute ecological environment anymore.

By virtue of these advantages, the present invention breaks through the boundaries of the prior art and has obvious utilization and advancement. It is of course to be understood that the embodiment described herein is merely illustrative of the principles of the invention and that a wide variety of modifications thereto may be effected by persons skilled in the art without departing from the spirit and scope of the invention as set forth in the following claims.

1. An ion engine comprises:
a dynamo possesses gas therein;
a super conductor disposed on the lateral side of the dynamo possesses the inconsumable specialty;
the said super conductor operates and releases high voltage to make the gas inside the dynamo be influenced by the high voltage and ionize so as to generate continuous and endless electromagnetic impulse.

2. The present invention of an ion engine according to claim 1 utilizes the super conductor to release high voltage to make the dynamo generate continuous and endless electromagnetic impulse; through the dynamo, the said electromagnetic impulse is connected to various electric products using the electricity as the energy.
